(19) United States
(12) Patent Application Publication
(10) Pub. No.: US 2013/0171424 A1
(43) Pub. Date: Jul. 4, 2013

(54) HOUSING AND METHOD FOR MAKING THE SAME

(71) Applicant: XU LIU, Shenzhen City (CN)

(72) Inventor: XU LIU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/451,081

(22) Filed: Apr. 19, 2012

(30) Foreign Application Priority Data
Dec. 29, 2011 (CN) 201110450419.3

(51) Int. Cl. B32B 3/10; B05D 3/06

(52) U.S. Cl. 428/172; 427/554

(57) ABSTRACT

A housing includes a transparent substrate, a first metallic layer formed on a first surface of the substrate, a transparent color layer formed on a second surface of the substrate opposite to the first metallic layer, and a second metallic layer formed on the color layer. The first metallic layer is defined a plurality of notches therein. A method for making the housing is also described.

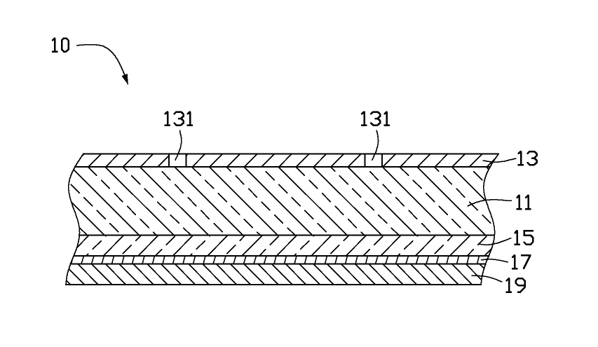

### BACKGROUND

1. Technical Field

The present disclosure relates to a housing and a method for making the housing.

2. Description of Related Art

Housings of electronic devices are usually coated with decorative coatings to present attractive appearances. The decorative coatings may be formed by spraying paint or ink, non-conductive vacuum metallization (NCVM), anodic treatment, or electroplating. However, these coatings cannot present a novel and pretty appearances.

Therefore, there is room for improvement within the art.

### BRIEF DESCRIPTION OF THE FIGURE

Many aspects of the disclosure can be better understood with reference to the following FIGURE. The components in the FIGURE are not necessarily drawn to scale, the emphasis instead being placed upon clearly illustrating the principles of the disclosure.

The FIGURE is a cross-sectional view of an exemplary embodiment of a housing.

### DETAILED DESCRIPTION

The FIGURE shows a housing 10 according to an exemplary embodiment. The housing 10 includes a transparent substrate 11, a first metallic layer 13 formed on a first surface of the substrate 11, a transparent color layer 15 formed on a second surface of the substrate 11 opposite to the pattern layer 13, a second metallic layer 17 formed on the color layer 15, and a protective layer 19 formed on the second metallic layer 17.

The substrate 11 may be made of transparent plastic. The plastic can be polycarbonate (PC), or polymethyl methacrylate (PMMA).

The first metallic layer 13 may be formed by a NCVM process. The first metallic layer 13 may be made of indium, tin, or indium-tin alloy. The first metallic layer 13 defines a plurality of notches 131 therein. Each notch 131 can have a width of about 0.05 millimeters (mm). Regions of the substrate 11 under the notches 131 are exposed via the notches 131. The first metallic layer 13 presents a metallic appearance.

The color layer 15 can be a colorful ink layer formed by spraying ink.

The second metallic layer 17 may be formed by a NCVM process. The second metallic layer 17 may be made of indium, tin, or indium-tin alloy. The second metallic layer 17 presents a metallic appearance.

Because the color layer 15 is transparent, the second metallic layer 17 can be observed from the first surface of the substrate 11 opposite to the second metallic layer 17. When observing from the first surface of the substrate 11 opposite to the second metallic layer 17, a deep metallic appearance having a composite color of the color layer 15 and the second metallic layer 17, combining the metallic appearance of the first metallic layer 13 will present.

The protective layer 19 may be an ink layer used to protect the second metallic layer 17. The protective layer 19 may have a dark color, which improves the reflection of light to enhance the metallic effect presented by the second metallic layer 17.

A method for making the housing 10 may include the following steps:

The substrate 11 is provided.

The substrate 11 is ultrasonic cleaned using absolute ethyl alcohol for about 5 min-about 10 min.

The first metallic layer 13 is formed on the first surface of the substrate 11. The first metallic layer 13 is formed by depositing a pre-metallic layer (not shown) on the whole of the first surface of the substrate 11 using a NCVM process using a target made of indium, tin, or indium-tin alloy first. Then portions of the pre-metallic layer are etched using laser to form the notches 131 and expose the regions of the substrate 11 under the notches 131. As such, the first metallic layer 13 is formed.

The color layer 15 is formed on the second surface of the substrate 11 opposite to the first metallic layer 13 by spraying ink. The ink is a transparent colorful ink. The spraying process may be carried out using the parameters of, spraying pressure: in a range of about 0.1 MPa-0.2 MPa, flow of the ink: in a range of about 12 L/min-about 15 L/min, distance for spraying: in a range of about 18 cm-about 20 cm, temperature for baking the sprayed ink: about 60° C.-about 70° C., and times for baking the sprayed ink: about 25 min-about 35 min. In the embodiment, the spraying pressure is about 0.15 MPa, the flow of the ink is about 13 L/min, the distance for spraying the ink is about 19 cm, the temperature for baking the sprayed ink is about 65° C., and baking the sprayed ink lasts for about 30 min.

The second metallic layer 17 is formed on the color layer 15 by a NCVM process using a target made of indium, tin, or indium-tin alloy.

The protective layer 19 is formed on the second metallic layer 17 by spraying ink. The spraying process may be carried out using the parameters of, spraying pressure: in a range of about 0.1 MPa-about 0.2 MPa, flow of the ink: in a range of about 13 L/min-15 L/min, distance for spraying: in a range of about 18 cm-about 20 cm, temperature for baking the sprayed ink: about 60° C.-about 70° C., and duration of time for baking the sprayed ink: about 30 min-about 40 min. In the embodiment, the spraying pressure is about 0.15 MPa, the flow of the ink is about 14 L/min, the distance for spraying the ink is about 19 cm, the temperature for baking the sprayed ink is about 65° C., and baking the sprayed ink lasts for about 35 min.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing, comprising:
a transparent substrate;
a first metallic layer formed on a first surface of the substrate, the first metallic layer being defined a plurality of notches therein;
a transparent color layer formed on a second surface of the substrate opposite to the first metallic layer; and
a second metallic layer formed on the color layer.

2. The housing as claimed in claim 1, wherein the first metallic layer is made of indium, tin, or indium-tin alloy.

3. The housing as claimed in claim 1, wherein each notch has a width of about 0.05 millimeters.

4. The housing as claimed in claim 1, wherein regions of the substrate under the notches are exposed via the notches.

5. The housing as claimed in claim 1, wherein the color layer is a colorful ink layer.

6. The housing as claimed in claim 1, wherein the second metallic layer is made of indium, tin, or indium-tin alloy.

7. The housing as claimed in claim 1, further comprising a protective layer formed on the second metallic layer.

8. The housing as claimed in claim 7, wherein the protective layer is an ink layer.

9. The housing as claimed in claim 1, wherein the substrate is made of transparent plastic.

10. The housing as claimed in claim 9, wherein the plastic is polycarbonate or polymethyl methacrylate.

11. A method for making a housing, comprising:
providing a transparent substrate;
forming a first metallic layer on a first surface of the substrate using a non-conductive vacuum metallization process, the first metallic layer being defined a plurality of notches therein;
forming a transparent color layer on a second surface of the substrate opposite to the first metallic layer; and
forming a second metallic layer on the color layer using a non-conductive vacuum metallization process.

12. The method as claimed in claim 11, wherein the notches are formed by etching using laser.

13. The method as claimed in claim 11, wherein forming the first metallic layer uses a target made of indium, tin, or indium-tin alloy.

14. The method as claimed in claim 11, wherein forming the color layer is carried out by spraying transparent colorful ink.

15. The method as claimed in claim 14, wherein the spraying process is carried out using the parameters of, spraying pressure: in a range of about 0.1 MPa-0.2 MPa, flow of the ink: in a range of about 12 L/min-15 L/min, distance for spraying: in a range of about 18 cm-20 cm, temperature for baking the sprayed ink: 60° C.-70° C., and times for baking the sprayed ink: 25 min-35 min.

16. The method as claimed in claim 15, wherein the spraying process is carried out using the parameters of, spraying pressure: 0.15 MPa, flow of the ink: 13 L/min, distance for spraying the ink: 19 cm, temperature for baking the sprayed ink: 65° C., and times for baking the sprayed ink: 30 min.

17. The method as claimed in claim 11, wherein forming the second metallic layer uses a target made of indium, tin, or indium-tin alloy.

18. The method as claimed in claim 11, further comprising a step of forming a protective layer on the second metallic layer.

19. The method as claimed in claim 18, wherein the protective layer is an ink layer formed by spraying ink.

20. The method as claimed in claim 19, wherein the spraying process is carried out using the parameters of, spraying pressure: in a range of about 0.1 MPa-0.2 MPa, flow of the ink: in a range of about 13 L/min-15 L/min, distance for spraying: in a range of about 18 cm-20 cm, temperature for baking the sprayed ink: 60° C.-70° C., and times for baking the sprayed ink: 30 min-40 min.
